(19) United States
(12) Patent Application Publication
(10) Pub. No.: US 2009/0117996 A1
(43) Pub. Date: May 7, 2009

(54) VIRTUAL ASSET EQUIVALENCY METHOD AND SYSTEM

(76) Inventors: Joshua James DEATH, Waterdown (CA); Dirk Olaf SCHRADER, Toronto (CA)

Correspondence Address: DIMOCK STRATTON LLP, 20 QUEEN STREET WEST SUITE 3202, BOX 102, TORONTO, ON, M5H 3R3, CA

(21) Appl. No.: 12/202,915

(22) Filed: Sep. 2, 2008

Related U.S. Application Data
(60) Provisional application No. 60/969,361, filed on Aug. 31, 2007.

(51) Int. Cl. A63F 9/24; A63F 13/00

(52) U.S. Cl. 463/25; 463/42

(57) ABSTRACT

A system is provided for creating an offer to a player to participate in a virtual world based on the value the player's virtual assets in a different virtual world having a host processor; a first data repository for virtual world offers and a second data repository for player avatar data. The host processor includes means for scoring said virtual world offers and said player avatar data and includes means for matching said virtual world offers and said player avatar data in accordance with said scoring. A method is provided for creating an offer to a player to participate in a virtual world based on the value the player's virtual assets in a different virtual world having the steps of receiving virtual world offers; receiving player avatar data; scoring said virtual world offers and said player avatar data; and matching said virtual world offers scores and said player avatar data scores.

### CROSS REFERENCE TO RELATED APPLICATIONS

This application claims the benefit of U.S. Provisional Patent Application No. 60/969,361, filed Aug. 31, 2007.

### FIELD OF INVENTION

The present invention relates to a data processing system and method for evaluating virtual assets and, more particularly, to a system and method for establishing equivalent values for virtual assets between a plurality of virtual worlds in a manner that enables virtual worlds to market to players in other virtual worlds and for players to leverage the value of their accumulated virtual assets across a plurality of virtual worlds.

### BACKGROUND OF THE INVENTION

The first and most fundamental problem faced by virtual world players today is that they each spend hundreds, if not thousands, of hours developing their virtual world assets and once they get bored of a particular virtual world and desires to leave, they have no choice but to close their account and as a result, lose all of their virtual world assets. This problem is a direct result of the manner in which virtual worlds conduct their business.

There are numerous virtual worlds that are currently in commercial operation, most of which are massively multiplayer online games such as World of Warcraft®, Everquest® and Guildwars®. Nearly all virtual worlds are created by developers with the objective to provide a unique gaming environment consisting of, among other things, player characters, non-player characters, terrain, game mechanics and storylines. This “content” is painstakingly created at a significant upfront cost with the ultimate intent of enticing players to participate in the virtual world and, hopefully maintain a subscription and/or purchase upgrades in order for the virtual world to generate revenue. More simply, most virtual world developers create content that is intellectual property, primarily copyright, that they seek to license to players for a fee. While this model may currently work for virtual worlds, it creates a number of problems, in particular, the virtual worlds must vigorously protect their intellectual property since that is the source of their revenue and second, the virtual worlds must attract a critical mass of players as soon as possible after launch to cover the upfront investment and generate a profit.

With regard to the first problem, virtual worlds protect their intellectual property by way of extensive terms and conditions of use that every player must agree to before being allowed to participate in the virtual world. With the exception of Linden's Second Life® such terms provide, in some form or another, that the virtual world retains all intellectual property rights, including in the characters the player develops (their Avatars) and even the player's account itself. This restrictive license enables the virtual world to maintain sole control and ownership over the intellectual property its developers have created including all derivative works thereto which are created by players participating in the virtual world. As such, virtual worlds are able to fully exploit their intellectual property rights to generate revenue. Part of that means stopping players from selling their Avatars or accounts, such as was done by the number one virtual world, World of Warcraft®, with player Avatar/account sales on eBay. These terms of use and their enforcement thereof in relation to the virtual world intellectual property rights, doesn't bode well with players as it effectively eliminates the ability of a player to leverage the virtual assets he or she has developed outside of the context of the virtual world those assets were created in.

With regard to the second problem, virtual worlds spend significant dollars on marketing campaigns and one-month free teaser accounts to attract players who will, hopefully, become subscribers. This ramp up of subscribers needs to happen shortly after the launch of the virtual world to get to the operational cost/revenue break-even point. If the virtual world does not attract a sufficient number of players within a short period after launch, the virtual world will fail. However, since the number of virtual world players is relatively small, this means that most virtual worlds are seeking to lure players away from other virtual worlds, essentially cannibalizing players from each other. As such, virtual worlds rely on their unique content, or intellectual property, to act as the primary lure of players. Otherwise, all players are considered equal and not marketed to in a more segmented or direct manner.

Hence, the current operational structure for most virtual worlds is based upon the development of intellectual property content that is the virtual worlds' primary marketing lure to attract players, which, once they become subscribers, are substantially restricted from using such intellectual property beyond the scope of the virtual world. Assuming the virtual worlds can cannibalize enough players to break even and that the players are satisfied with such restricted use, it seems like a perfect closed loop. However, most virtual worlds fail because they cannot cannibalize enough players and the virtual worlds that do succeed have a number of discontent players.

As such, there is a need for an invention which will recognize the virtual assets of a virtual world player in a context other than the virtual world that the player has developed such virtual assets. There is a need for an invention which will enable players and other virtual worlds to leverage a player's virtual assets without infringing the intellectual property rights of the virtual world that owns such virtual assets. There is a need for a marketing channel for virtual worlds to directly market to virtual world players in order to rapidly grow the virtual world's subscriber base. The present invention addresses these needs.

### DESCRIPTION

### Summary of the Invention

Aspects of the invention include systems for creating an offer to a player to participate in a virtual world based on the value the player's virtual assets in a different virtual world, comprising: a host processor; a first data repository for virtual world offers; a second data repository for player avatar data; said host processor including means for scoring said virtual world offers and said player avatar data; and said host process including means for matching said virtual world offers and said player avatar data in accordance with said scoring.

Aspects of the invention include methods for creating an offer to a player to participate in a virtual world based on the value the player's virtual assets in a different virtual world, comprising the steps of: receiving virtual world offers; receiving player avatar data; scoring said virtual world offers and said player avatar data; and matching said virtual world offers scores and said player avatar data scores.

It is to be understood that both the foregoing general description and the following detailed description are exemplary and explanatory only, and are not restrictive of the invention claimed. The accompanying drawings constitute a part of the specification, illustrate certain embodiments of the invention and, together with the detailed description, serve to explain the principles of the invention.

### BRIEF DESCRIPTION OF DRAWINGS

FIG. 1 is an architectural diagram of the system to implement the invention.

FIG. 2 is a flow diagram illustrating the method of application of the invention to equate virtual world offers with virtual world players.

FIG. 3 is a flow diagram illustrating the method of application of the invention for virtual world companies to set up offers.

FIGS. 4 a-f are examples of templates that virtual worlds would use to input offers.

FIG. 5 is a flow diagram illustrating the method of application of the invention for virtual world players log on to the system and have matched virtual world offers presented.

### DETAILED DESCRIPTION

“CVW” means customer virtual world.

“VW” means virtual world.

“VWX” means the host computer 110.

“WOW” means World of Warcraft®.

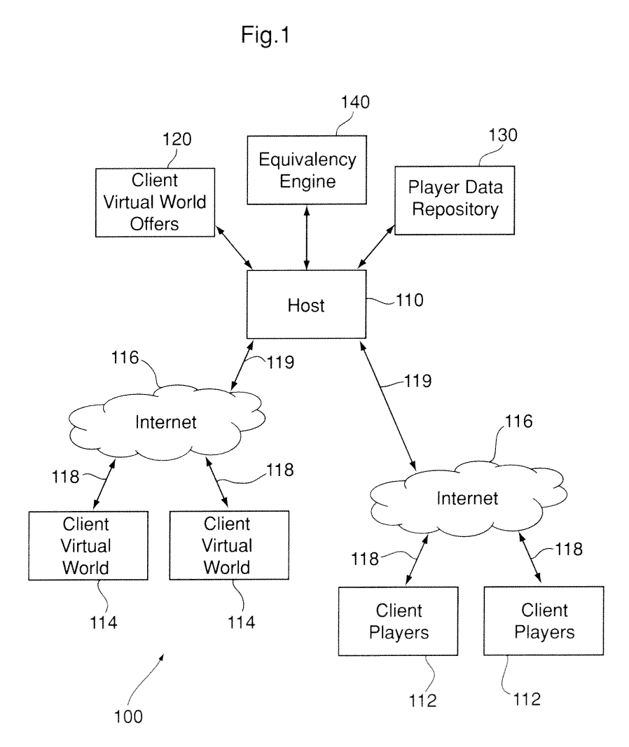

FIG. 1 shows a diagram of a system 100 that may be used to implement aspects of the invention. A plurality of player computers 112 and virtual world computers 114 may be networked to the host computer 110 by way of a wide area network, such as the internet 116. Player computer 112 provides players with a user interface for displaying virtual world offers to players, and enables players to interact with host computer 110 for purposes of inputting player data and accepting virtual world offers by way of input devices such as keyboards, mice or other such input means. Virtual world computer 114 provides virtual worlds with a user interface to interact with host computer 110 by way of said inputting means.

Host computer 110 hosts the virtual world data repository 120 and the player data repository 130 and hosts and operates the input interface for both such systems and the equivalency engine 140. The virtual world data repository 120 stores virtual world registration data and offers created by such virtual worlds. The player data repository 130 stores player registration and player virtual asset data. The equivalency engine or matrix 140 utilizes a database engine to create a matrix that matches the virtual world offers with the player virtual asset data.

The virtual world computers interface 114, enables virtual world operators to interact with host computer 110 and select from a plurality of competing virtual worlds that such virtual world operator desires to create offers for players in relation to.

The player computer interface 112, enables players of virtual worlds to interact with host computer 110 and input such player virtual asset information, including, but not limited to, information relating to the player's virtual characters or avatars, as prompted by the host computer 110.

The equivalency engine 140 matches offers stored in the virtual world data repository 120 with player virtual assets stored in the player's data repository. Once a match is found, the host computer 110 communicates the virtual world offer to the player by way of email, texting or other such push communication. Alternatively, the host computer 110 stores the matched offer for display to the player the next time the player logs into the host computer.

One or more of the computer devices and terminals shown in FIG. 1 may include a variety of interface units and drives for reading and writing data or files. One skilled in the art will appreciate that networks 118 and 119 are for illustration purposes and may be replaced with fewer or additional computer networks.

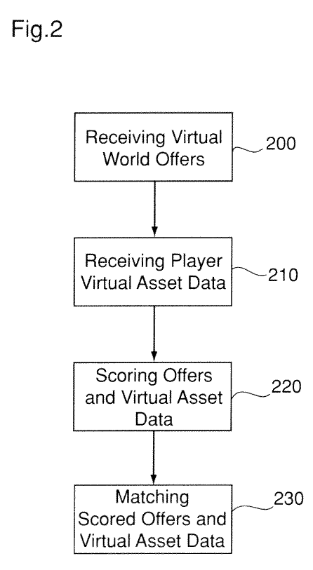

FIG. 2 illustrates a method of determining virtual world offers for players in an embodiment of the invention. The method may be implemented by the host computer being executed on a computer such as host computer 110.

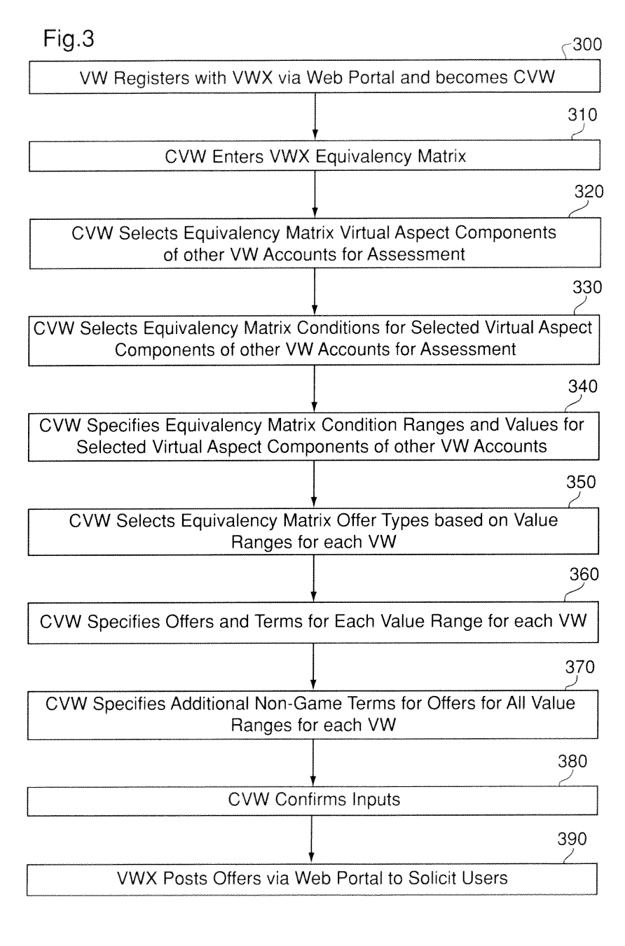

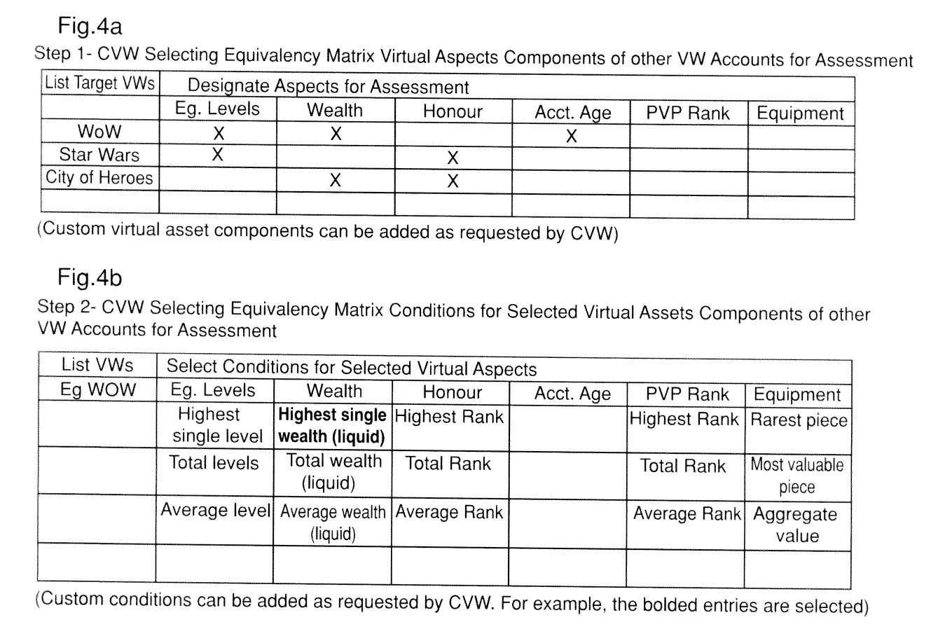

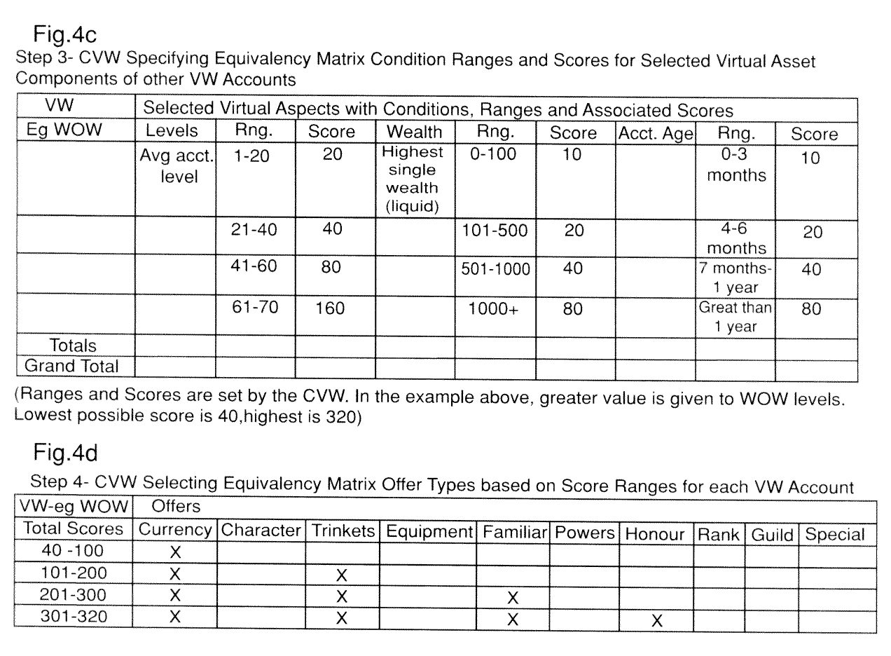

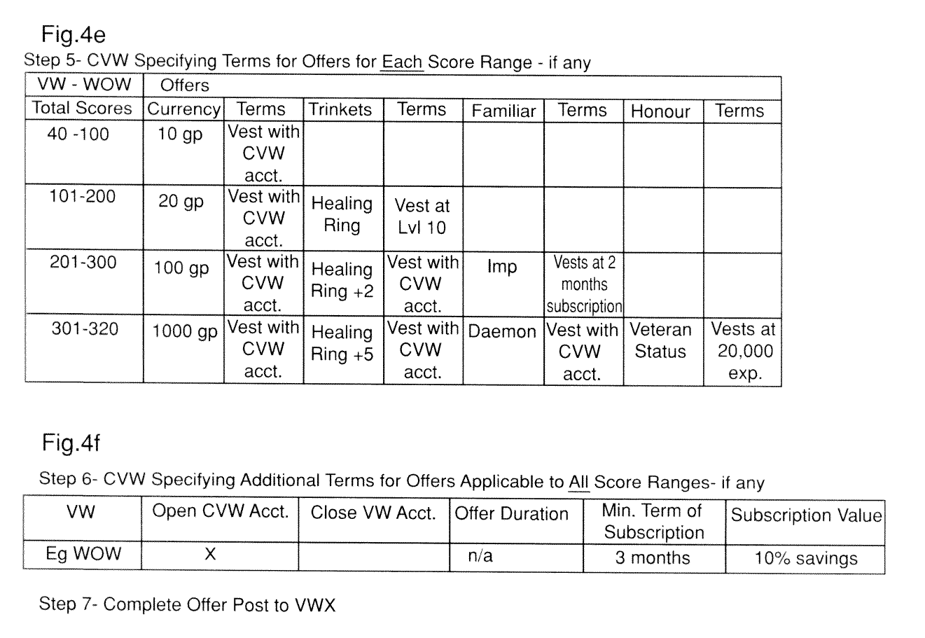

FIG. 3 illustrates the method how virtual world offers 200 are received. Before a virtual world can setup offers, it must first register 300 with the host computer 110 in order that its inputs can be stored and utilized by the host computer 110 to finding player data that matches such virtual world offer. Once a virtual world is registered it can log on 310 to the host computer 110. Once logged in, the host computer 110 presents the virtual world with a user interface as exemplified in FIGS. 4 a-f. The first step for a virtual world to create an offer is to select the competing virtual worlds 320 which it desires to make offers in relation to, an example of which is shown in FIG. 4 a “List Target VWs”. A virtual world may select one or any number of target virtual worlds from a pull down list or other such list. For example, a virtual world may have 3-4 direct competitors which all present a similar gaming environment, such as fantasy genre, and which all compete for the same player accounts. As such, the virtual world would likely select such virtual worlds for the purpose of creating offers to the players of such virtual worlds. Upon the selecting the target virtual worlds for offers, the host computer 110 presents the virtual world with a number of primary options or primary aspects of the target virtual world which can be selected to for the basis of the offer conditions, an example of which is shown in FIG. 4 a “Designate Aspects for Assessment”. For example, a virtual world may select none of the primary aspects since it's interested in creating offers that would target all players of such selected virtual worlds. Conversely, a virtual world may select one or any number of the primary aspects, such as player avatar levels, wealth, honor, ranking, equipment, account age and so on, in order to target a certain type of player, such as an active player. Further, a virtual world may select different primary aspects for each targeted virtual world. For example, a virtual world may select player avatar levels for target virtual world A and player avatar wealth for target virtual world B. The above noted primary aspects are by way of example only, any aspect of a player avatar that has related data can be set up as a primary aspect or condition for selection by a virtual world, including combinations of such player avatar data.

Once a virtual world has selected the target virtual worlds and primary aspects in relation thereto, a virtual world will need to select the conditions associated with each primary aspect 330, an example of which is shown in FIG. 4 b “Select Conditions for Selected Virtual Aspects”. The conditions set out the manner by which the primary aspects will be assessed. For example, if a virtual world selected player avatar “wealth” as a primary aspect, the conditions may include total liquid wealth of all avatars in the player account, the greatest liquid wealth of a single avatar, all the liquid and illiquid (if the avatar sold all its armor, equipment, weapons and so on) wealth of all avatars in the player account, or the greatest liquid and illiquid wealth of a single avatar. If a virtual world selected player avatar “Levels” as a primary aspect, then the conditions may include highest level of a single avatar in the player account, the average levels of all avatars in the player account or the total of all the avatar levels. The foregoing are examples only, any other conditions can be created in relation to the primary aspect selected.

Once a virtual world has selected the target virtual worlds, the primary aspects and associated conditions, the next step is to specify the ranges in relation to each such associated condition 340, an example of which is shown in FIG. 4 c “Selected Virtual World Aspects with Conditions, Ranges and Associated Values”. The ranges separate the conditions into various groups in order that a virtual world can associated different offers against greater or lesser condition values. For example, a virtual world that has selected “Levels” as a primary aspect, and “Total Levels” as the condition may select “Total Level” ranges that go from 0 to 1000 in increments of 100. As such, the Total Level ranges would be 0-100, 101-200, 201-300 and so on up to 901-1000 and 1000+. Similarly if “Wealth” was selected as a primary aspect and “Average Wealth” was selected as the condition, a virtual world may select “Average Wealth” ranges from 0 to 10,000 in increments of 1000. As such the Average Wealth ranges would be 0-1000, 1001-2000 and so on up to 9001, 10000 and 10000+. The foregoing are examples only and a virtual world may input any ranges it desires in association with the selected primary aspect conditions.

In the event a virtual world only selects one primary aspect, then a virtual world proceeds to the next step, associating offer types with each range 350. However, in the event a virtual world has selected more than one primary aspect to be considered in the offer process, then a virtual world must either assign a standardized value from 1-100 to each such range or rank the primary aspects according to how player data will be filtered to find a match for the aggregate offer aspects, conditions and ranges, an example of which is shown in FIG. 4 c “Selected Virtual World Aspects with Conditions, Ranges and Associated Scores”. For example, in the first case, in the event a virtual world has selected Total Levels as the only primary aspect for offers, then there is no need for further processing of the offer since the host computer 110 will filter player data based on whether or not they participate in a target virtual world, sum the player level data and compute it directly as the score and associate such player data with the corresponding score range established by the virtual world and thereby identify the corresponding virtual world offer to such players. In the second case, in the event a virtual world has selected more than one primary aspect for consideration in presenting offers, such as Total Levels and Total Wealth, the virtual world needs to identify how it desires to have such primary aspects calculated by the host computer 110. The simplest manner is for the virtual world to rank the primary aspects from 1 to 10, or other such ranking means. The host computer 110 will filter such primary aspects according to the ranking. For example if Total Levels was ranked first and Total Wealth ranked second, the host computer would filter the player data based first on target virtual world, then Total Levels according to the conditions, associated ranges and scores and then Total Wealth, also according to the conditions, associated ranges and scores. Once such filtering of the player data was completed, offers that match such filtered data could be associated with such players and the next step could be executed. Another method which a virtual world may use to assess all of the selected primary aspects holistically, and the preferred embodiment, is for the virtual world to designate a score from 1-100 (or any other such numerical range) with each range for each primary aspect condition. An example of which is shown in FIGS. 4 c-e. The host computer uses such scores to create a total score for each offer and records such total score in association with the offer in the virtual world offer repository 120.

Once the target virtual worlds, associated primary aspects, condition, ranges and ranking means have been selected, the next step is to select offer types and associated score range in relation to player data, 350, an example of which is shown in FIG. 4 c “Selected Virtual World Aspects with Conditions, Ranges and Associated Scores”. A virtual world can select from a large range of offer types such as virtual gold based, character based, equipment based, abilities based, familiar based, rank based and guild based. Further, a virtual world may provide other offer types of their own devising that can be inputted into the host computer 110. Further, a virtual world can select one or any number of offer types that can be provided individually or in combination. As part of the offer type selection process, a virtual world will designate which offer types are associated with which scoring or ranking, as such scoring or ranking is calculated. For example, if a virtual world selected just one primary aspect, such as Levels with the condition of Highest Level, then the offer types could be set out based on the Highest Level ranges. At range 0-10 the offer type may be just virtual gold based. At range 60-70 the offer type may be a combination of virtual gold based and equipment based. The player data relating to their actual levels would be sufficient for ranking such offer types since that would be used as the score. If a virtual world selected more than one primary aspect, such as Levels and Wealth and selected to filter player data based on a prioritization or ranking means, then again, the raw player data could be used to determine which offer type is applicable. Lastly, if a virtual world selected more than one primary aspect, such as Levels and Wealth and selected to score such offer criteria together by way of using scores associated with each primary aspect condition range, then such virtual world would need to also identify the applicable aggregate scores that would be applicable to each offer type. For example, if a primary aspect is Level, the condition Highest Level and the Range for 60-70 equal to a score of 50 and the next primary aspect is Wealth, the condition Total Wealth and the Range for 1001-2000 equal to a score of 60, then the aggregate score for such a player would be equal to 110. As such, a virtual world would need to associate scores ranges with each of the selected offer types.

Once the target virtual worlds, the primary aspects, associated conditions, ranges, offer types and scoring, if applicable, have been selected, the next step is to input the actual offer the virtual world is willing to provide to such players whose data matches the above noted criteria 360, an example of which is shown in FIG. 4 d “Offers”. Assuming a virtual world has selected such ranges, there may be a number of different offers. For example, if a virtual world has selected the primary aspect of Levels, the condition Highest Level for a Single Avatar, Ranges 0-40 and 41-80, virtual gold based offer for Range 0-40 and virtual gold based and equipment based for Range 41-80, then the actual offer to the player may be 100 virtual gold in the virtual world for Range 0-40 and 200 virtual gold, plus a special virtual shield, sword, wand or dagger for Range 41-80. This would be applicable whether the Range was calculated based on the actual player data for Levels or by using the standardized value means to create a score. The actual offer is entirely in the discretion of the virtual world and the host computer 110 allows for any such offer to be inputted at this stage since the correlation process between offer conditions and player data has been completed. As such, a virtual world could offer anything from level bonuses, unique virtual items such as equipment, armor, weapons, spells, familiars, honor, trinkets and so on. In the event the virtual world has just selected target virtual worlds and skipped the remaining criteria establishing steps, then there may just be one actual offer that is available to all players that participate in a target virtual world.

The next step for a virtual world to create an offer is to establish set the legal terms and conditions of the other 370, an example of which is shown in FIG. 4 f. The legal terms supplement the standard terms and condition that any player must agree to in order to be able to participate in the virtual world. Normally there are no fixed periods that a player must subscribe to a virtual world or how much a player must purchase within a virtual world or other such requirements. A virtual world may elect at this stage to attach such terms to the offer, such as a 3 month subscription commitment and so on. For a player to select an offer, they must also agree to the legal terms. The advantage of this option is that the virtual world can “lock-in” high value players that it has targeted by way of the offers creation process set out above. In addition to the legal terms for the players, the virtual world associates a promotional code with each offer created. The promotional code is the means by which the host computer will identify players to the virtual world that have qualified for, and accepted, a virtual world offer. The promotional code is also the means by which the virtual world will be able to identify which players to provide the offers.

Once the virtual world has selected the target virtual worlds, primary aspects, associated conditions, ranges, scores, offer types, offers and legal terms, then the virtual world can review and confirm such offers 380. Once confirmed, the offers, including all associated criteria, are posted 390 to the virtual world offers repository 120 and the process of corresponding player virtual asset data with such offers commences by way of the host computer 110 executing the equivalency engine 140.

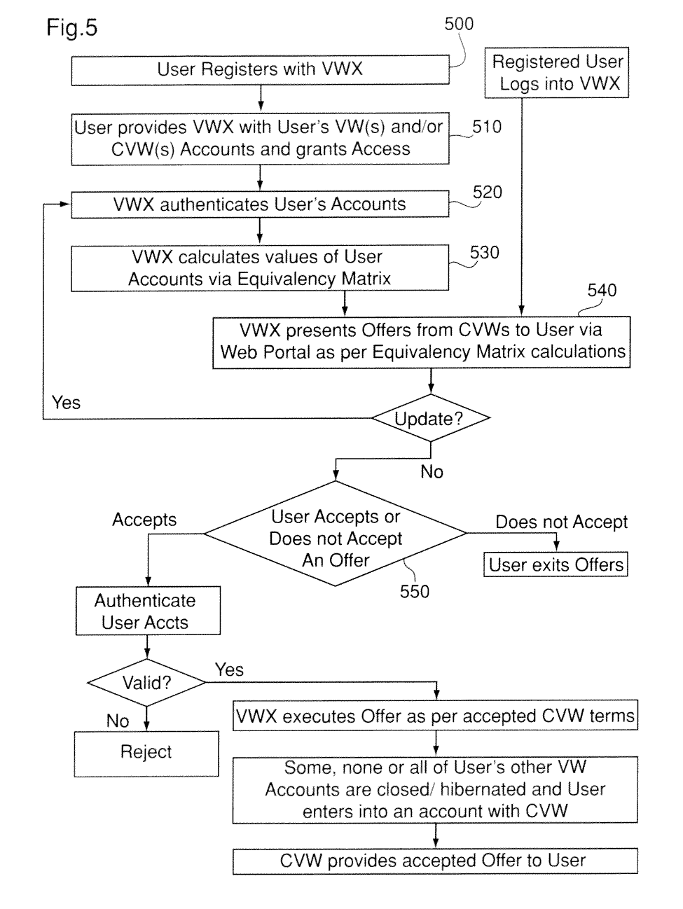

FIG. 5 illustrates the method how player avatar data 210 is received. Before a player can receive an offer from a virtual world, he or she must first register 500 with the host computer 110. The registration process for players can be accomplished by two different methods. In one method, the player can merely enter his or her name, unique account name and password in the host computer and provide the name of the virtual world he or she participates in and the associated account name and password for such virtual world(s) 510. Thereafter, the host computer will access such player virtual world account and acquire the player data directly and thereby authenticate the player account 520. In the alternative, and the preferred embodiment, the player enters his or her name, unique account name, password and enters into a template information about his or her virtual assets, including, for example, the virtual worlds associated with the players characters, avatars, their statistics, such as level, rank, honor, wealth, character class and type, key equipment, achievements and so on. Whatever data exists in a particular world about such player virtual assets a template can be created to capture same. For each virtual asset inputted, such as a character or avatar, the player provides a screen capture image and uploads same to the host computer 110 in order that the avatar data entered by the player can be authenticated 520.

Once the player has been registered with the host computer 110 and provided his or her virtual asset data and had same authenticated, the next step is for the host computer 110 to score the player's virtual assets 530 against each of the existing virtual world offers stored with in the virtual world offers repository 120. Once the host computer has scored the player virtual assets, the host computer, by way of the equivalency engine 140, matches such scored player virtual asset data with equivalently scored virtual world offers 540. In the event there is a match, the host computer presents the offers to the player by way of the player user interface. A player may be presented with zero, one or many offers that match from virtual worlds that have set up offers on the host computer 110. A unique aspect of the subject invention is that a player can potentially receive numerous offers, none of which are identical, but all of which are derived from the same set of player virtual asset data. It is this reason why the subject invention described as an equivalency system and method, not an exchange system and method.

The next step is for the player to review the offers and associated legal terms, if any, and decide whether player wishes to accept one or many offers 550. If the player accepts at least one offer from a virtual world the host computer links the player with the registration interface for offer presenting virtual world to complete the offer acceptance and register with the selected virtual world. As part of the transfer to the selected virtual world, the host computer provides a masked promotional code that correlates with the particular offer created by the virtual world and accepted by the player at hand. If the player does not accept any offers, the player can exit the offers interface.

The advantage of this system and method is that it enables players to leverage the virtual assets they have developed to get preferential offers for joining and participating in other virtual worlds. As such, the player is able to continually build on his or her efforts across the virtual world meta-universe. Further, the player can attain this leverage without violating the terms of use, and in particular, intellectual property rights, of his or her current virtual world. The advantage of this system and method for virtual worlds is that it creates a new direct marketing channel for virtual worlds to target players from competing virtual worlds in order to grow its subscriber user base. This system and method is particularly important for new virtual worlds that need to grow their subscriber/user base as rapidly as possible in order to become a revenue positive business.

FIG. 5 illustrates the method used by the host computer 110 to match the virtual world offers with the player avatar data 220.

While the invention has been described with respect to specific examples including presently preferred modes of carrying out the invention, those skilled in the art will appreciate that there are numerous variations and permutations of the above described systems and techniques that fall within the spirit and scope of the invention.

1. A system for creating an offer to a player to participate in a virtual world based on the value the player's virtual assets in a different virtual world, comprising:
a host processor;
a first data repository for virtual world offers;
a second data repository for player avatar data;
said host processor including means for scoring said virtual world offers and said player avatar data; and
said host process including means for matching said virtual world offers and said player avatar data in accordance with said scoring.

2. A method for creating an offer to a player to participate in a virtual world based on the value the player's virtual assets in a different virtual world, comprising the steps of:
receiving virtual world offers;
receiving player avatar data;
scoring said virtual world offers and said player avatar data; and
matching said virtual world offers scores and said player avatar data scores.
